(19) United States
(12) Patent Application Publication
(10) Pub. No.: US 2012/0192446 A1
(43) Pub. Date: Aug. 2, 2012

(54) Right Handed Tape Measure

(76) Inventor: Laurencio Javian, Oakley, CA (US)

(21) Appl. No.: 13/015,737

(22) Filed: Jan. 28, 2011

(51) Int. Cl. G01B 3/10

(52) U.S. Cl. 33/701; 33/755

(57) ABSTRACT

The present invention relates to a measuring device for measuring a desired length and a method of using the device, where the device comprises: a metal casing; a retractable tape measure extending from the right side of the metal casing; and numerical markings on the tape measure, where the numerical markings increase from right end of the tape to the left toward the metal casing when the tape measure is extended from the metal casing. The numerical markings may designate either inches or centimeters and may include sub-units thereof.

### BACKGROUND OF THE INVENTION

1. Field of Invention

The present invention relates to a tape measure that is suitable for the right-handed user.

2. Description of Related Art

A tape measure or a measuring tape is a flexible form of a measuring device that includes markings in either inches or centimeters. Many tape measures include markings for half, quarter, eighth, sixteenth inches. The markings extend the length of the tape as it is stretched over a length for measurement purposes. Tape measures are made of cloth, plastic or metal strips. One commonly used tape measure is one that the metal strip that is commonly rolled into a metal case. Many of these metal strips are self-retracting tape measures that extend over a length. The most commonly used tape measure pulls out from the left side of the metal casing and the numbering reads from left to right over the length of the tape measure. Such a tape measure may be inconvenient and awkward to position for right-handed individuals. A right-handed user must hold the metal case with their right hand as the tape measure extends over the desired length and therefore making it difficult to make markings as the tape measure is extended. The right-handed user must typically use their left hand to make markings while holding the metal case in the right hand.

It would therefore be advantageous to have a tape measure that extends in the opposite direction where the tape is pulled to the right and the metal case may be held with the left hand as it extends over the length of measurement. Therefore measurement of the length would begin at the right side or right end of the object and allows the right-handed user to make markings with their right hand.

### SUMMARY OF THE INVENTION

The present invention relates to a measuring device for measuring a desired length comprising: a metal casing; a retractable tape measure extending from the right side of the metal casing; and numerical markings on the tape measure, where the numerical markings increase from right end of the tape to the left toward the metal casing when the tape measure is extended from the metal casing. The numerical markings may designate either inches or centimeters and may include sub-units thereof.

The present invention further includes a method of measuring a linear distance comprising the steps of: grasping a metal casing with a left hand, where the metal casing includes a retractable tape measure with numerical markings; extending the tape measure from the right side of the metal casing; reading the linear distance associated with the numerical markings on the tape measure; and making notations associated with the linear distance.

### BRIEF DESCRIPTION OF DRAWINGS

FIG. 1A depicts a right-handed tape measure in accordance with the present invention.

FIG. 1B shows a sectional view of the tape measure according to present invention.

### DETAILED DESCRIPTION

The present invention provides a tape measure which extends outwardly from the right side of a metal casing and therefore provides a more suitable tape measure for use by a right-handed user. The use of a tape measure in accordance with the present invention allows a right-handed user to more easily record accurate measurements and therefore make suitable markings as needed with the use of the tape measure which extends from right to left of the holder.

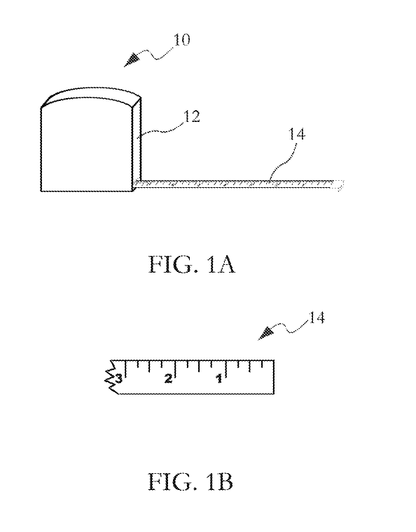

A measuring device 10 according to the present invention is depicted in FIG. 1A. The measuring device 10 includes a metal casing 12 and a metal tape measure that extends outwardly from the right side of the metal casing 12. The tape measure 14 includes numerical markings for measurement of length along the length of the tape measure. The linear markings may be marked in inches or centimeters as desired by the user. The numbering advances from right to left from the beginning of the tape measure until the end thereof. Use of the measuring device 10 according to the present invention frees up the right hand to make markings and notations as needed when using the tape measure. By using the measuring device 10, the user holds the metal case 12 with the left hand and extends the tape measure as needed in making markings and notations.

FIG. 1B depicts a sectional view of the tape measure 14 where numerical markings are shown that extend from right to left. As stated above the linear markings may be in a form of inches, centimeters or other desired measured lengths along the tape measure. Subunit markings may be provided for example half inch, quarter inch or eighth inch linear markings. The numerical markings provided on the top side of the measuring tape 14 enables the right-handed user to extend the tape from right to left using the left hand to hold the casing 12 where the numbers are displayed appropriately for use by the right-handed user.

The measuring device 10 may include a belt clip on one side thereof, not shown, that enables the placement of the device onto a user's belt for convenient access. The device 10 may also include a locking mechanism to lock the tape 14 in an extended position during use. In one particular embodiment of the present invention, a clip on the tip of tape 14 may be used to hold the tape 14 in an extended position. In another exemplary embodiment, the tape 14 includes a magnetized bottom so that the tape 14 may adhere to metal surfaces such as steel or iron.

Use of the measuring device according to the present invention eliminates the awkward position of using a conventional tape measure which extends from the left side of a metal casing and is read from left to right. Also it makes it easier for the right-handed user to make markings as needed when using the measuring device. The instant invention has been shown and described in what it considers to be the most practical and preferred embodiments. It is recognized, however, that departures may be made there from within the scope of the invention and that obvious modifications will occur to a person skilled in the art.

What is claimed is:

1. A measuring device for measuring a desired length comprising:
a. a metal casing;
b. a retractable tape measure extending from the right side of the metal casing; and
c. numerical markings on the tape measure, where the numerical markings increase from right end of the tape to the left toward the metal casing when the tape measure is extended from the metal casing.

2. The measuring device according to claim 1, where the tape includes a magnetized bottom.

3. The measuring device according to claim 1, where said numerical markings designate at least one of inches and centimeters.

4. The measuring the device according to claim 3, where said numerical markings include sub-units.

5. The measuring the device according to claim 1, further including a locking means to lock the tape in an extended position.

6. A method of measuring a linear distance comprising the steps of:
a. grasping a metal casing with a left hand, where the metal casing includes a retractable tape measure with numerical markings;
b. extending the tape measure from the right side of the metal casing;
c. reading the linear distance associated with the numerical markings on the tape measure; and
d. making notations associated with the linear distance.
